(19) United States
(12) Patent Application Publication
(10) Pub. No.: US 2022/0330068 A1
(43) Pub. Date: Oct. 13, 2022

(54) METHODS, DEVICES AND COMPUTER STORAGE MEDIA FOR CSI FEEDBACK

(71) Applicant: NEC CORPORATION, Tokyo (JP)

(72) Inventors: Fang YUAN, Beijing (CN); Gang WANG, Beijing (CN)

(73) Assignee: NEC CORPORATION, Tokyo (JP)

(21) Appl. No.: 17/634,670

(22) PCT Filed: Aug. 15, 2019
(86) PCT No.: PCT/CN2019/100856

§ 371 Date: Feb. 11, 2022

(51) Int. Cl. H04W 24/10; H04W 24/08; H04L 5/00

(52) U.S. Cl. CPC H04W 24/10; H04W 24/08; H04L 5/0048

(57) ABSTRACT

Embodiments of the present disclosure relate to methods, devices and computer readable media for channel state information (CSI) feedback. A method comprises determining, at a terminal device, a reference signal resource for coherence measurement of a channel between the terminal device and a network device; performing the coherence measurement using the reference signal resource; and transmitting, to the network device, information indicating a result of the coherence measurement as a part of CSI for the channel.

### TECHNICAL FIELD

Embodiments of the present disclosure generally relate to the field of telecommunication, and in particular, to methods, devices and computer storage media for Channel State Information (CSI) feedback.

### BACKGROUND

Communication technologies have been developed in various communication standards to provide a common protocol that enables different wireless devices to communicate on a municipal, national, regional, and even global level. An example of an emerging communication standard is new radio (NR), for example, 5G radio access. NR is a set of enhancements to the Long Term Evolution (LTE) mobile standard promulgated by Third Generation Partnership Project (3GPP).

In the communication systems, generally CSI of a communication channel between a terminal device and a network device is estimated at the receiving terminal device and fed back to the network device to enable the network device to control transmission based on the current channel conditions indicated by the CSI. According to the NR technology, the feedback of CSI is based on CSI for purpose of for example CSI acquisition and beam management.

### SUMMARY

In general, example embodiments of the present disclosure provide methods, devices and computer storage media for CSI feedback.

In a first aspect, there is provided a method for communication. The method comprises determining, at a terminal device, a reference signal resource for coherence measurement of a channel between the terminal device and a network device; performing the coherence measurement using the reference signal resource; and transmitting, to the network device, information indicating a result of the coherence measurement as a part of channel state information, CSI, for the channel.

In a second aspect, there is provided a method for communication. The method comprises receiving, at a terminal device, control information from a network device; determining, based on the control information, the number of transmission occasions across which demodulation reference signals, DMRSs, are bundled; and performing joint channel estimation based on the DMRSs received from the network device across the transmission occasions.

In a third aspect, there is provided a method for communication. The method comprises performing, at a network device, transmission to a terminal device using a reference signal resource, to enable the terminal device to perform a coherence measurement of a channel between the terminal device and the network device; and receiving, from the terminal device, information indicating a result of the coherence measurement as a part of channel state information, CSI, for the channel.

In a fourth aspect, there is provided a method for communication. The method comprises determining the number of transmission occasions across which DMRSs are bundled, the DMRSs to be transmitted to the terminal device; generating control information indicating the number of the transmission occasions; and transmitting the control information to the terminal device to enable the terminal device to perform joint channel estimation based on the DMRSs received across the transmission occasions.

In a fifth aspect, there is provided a terminal device. The terminal device comprises a processor and a memory. The memory is coupled to the processor and stores instructions thereon. The instructions, when executed by the processor, cause the terminal device to perform actions comprising determining a reference signal resource for coherence measurement of a channel between the terminal device and a network device; performing the coherence measurement using the reference signal resource; and transmitting, to the network device, information indicating a result of the coherence measurement as a part of channel state information, CSI, for the channel.

In a sixth aspect, there is provided a terminal device. The terminal device comprises a processor and a memory. The memory is coupled to the processor and stores instructions thereon. The instructions, when executed by the processor, cause the terminal device to perform actions comprising receiving control information from a network device;

determining, based on the control information, the number of transmission occasions across which demodulation reference signals, DMRSs, are bundled; and performing joint channel estimation based on the DMRSs received from the network device across the transmission occasions.

In a seventh aspect, there is provided a network device. The network device comprises a processor and a memory. The memory is coupled to the processor and stores instructions thereon. The instructions, when executed by the processor, cause the network device to perform actions comprising performing transmission to a terminal device using a reference signal resource, to enable the terminal device to perform a coherence measurement of a channel between the terminal device and the network device; and receiving, from the terminal device, information indicating a result of the coherence measurement as a part of channel state information, CSI, for the channel.

In an eighth aspect, there is provided a network device. The network device comprises a processor and a memory. The memory is coupled to the processor and stores instructions thereon. The instructions, when executed by the processor, cause the network device to perform actions comprising determining the number of transmission occasions across which DMRSs are bundled, the DMRSs to be transmitted to the terminal device; generating control information indicating the number of the transmission occasions; and transmitting the control information to the terminal device to enable the terminal device to perform joint channel estimation based on the DMRSs received across the transmission occasions.

In a ninth aspect, there is provided a computer readable medium having instructions stored thereon. The instructions, when executed on at least one processor, cause the at least one processor to perform the method according to the first aspect of the present disclosure.

In a tenth aspect, there is provided a computer readable medium having instructions stored thereon. The instructions, when executed on at least one processor, cause the at least one processor to perform the method according to the second aspect of the present disclosure.

In an eleventh aspect, there is provided a computer readable medium having instructions stored thereon. The instructions, when executed on at least one processor, cause the at least one processor to perform the method according to the third aspect of the present disclosure.

In a twelfth aspect, there is provided a computer readable medium having instructions stored thereon. The instructions, when executed on at least one processor, cause the at least one processor to perform the method according to the fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 is a schematic diagram illustrating an example process in accordance with some embodiments of the present disclosure;

FIGS. 3A-3C show schematic diagrams illustrating example structures for reporting coherence according to some embodiments of the present disclosure;

FIG. 4 shows a schematic diagram illustrating bundling of DMRSs in frequency domain according to some embodiments of the present disclosure;

FIG. 5 shows a schematic diagram illustrating bundling of DMRSs in time domain according to some embodiments of the present disclosure;

FIG. 6 shows a schematic diagram illustrating settings related to CSI in frequency domain according to some embodiments of the present disclosure;

FIG. 7 shows a schematic diagram illustrating settings related to CSI in time domain according to some embodiments of the present disclosure;

FIG. 8 is a schematic diagram illustrating an example process in accordance with some embodiments of the present disclosure;

FIG. 9 illustrates an example method in accordance with some embodiments of the present disclosure;

FIG. 10 illustrates an example method in accordance with some embodiments of the present disclosure;

FIG. 11 illustrates an example method in accordance with some embodiments of the present disclosure;

FIG. 12 illustrates an example method in accordance with some embodiments of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

As used herein, the term “Transmission and Reception Point” (TRP) may refer to an antenna array (with one or more antenna elements) available to the network device located at a specific geographical location. For example, a network device may be coupled with multiple TRPs in different geographical locations to achieve better coverage. Alternatively or in addition, multi TRPs may be incorporated into a network device, or in other words, the network device may comprise the multi TRPs. It is to be understood that the TRP may also be referred to as a “panel”, which also refers to an antenna array (with one or more antenna elements) or a group of antennas. It is to also be understood that the TRP may refer to a logical concept which may be physically implemented by various manner.

As used herein, the term “beam” refers to a resource(s) in the spatial domain and is indicated by a set of parameters. In 3GPP specifications for NR, the beam may be indicated by the quasi-colocation (QCL) type D information, which is included in a Transmission Configuration Indication (TCI) state. The beam for PDSCH as used herein is used for reception.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, when two different signals share the same quasi co-location (QCL) type, they share the same indicated properties. As an example, the QCL properties may be e.g. delay spread, average delay, Doppler spread, Doppler shift, spatial reception (RX).

QCL type A means Doppler spread, Doppler shift, delay spread, and/or average delay, and QCL type D means spatial RX. Currently, QCL types are defined as following:

‘QCL-TypeA’: {Doppler shift, Doppler spread, average delay, delay spread}

‘QCL-TypeB’: {Doppler shift, Doppler spread}

‘QCL-TypeC’: {Doppler shift, average delay}

‘QCL-TypeD’: {Spatial Rx parameter}.

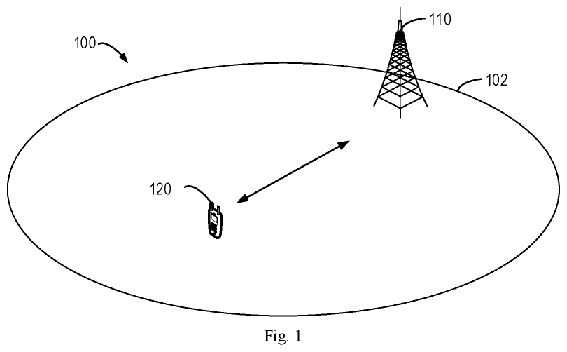

FIG. 1 shows an example communication network 100 in which implementations of the present disclosure can be implemented. The network 100 includes a network device 110 and a terminal device 120 served by the network device 110. The serving area of the network device 110 is called as a cell 102. It is to be understood that the number of network devices and terminal devices is only for the purpose of illustration without suggesting any limitations. The network 100 may include any suitable number of network devices and terminal devices adapted for implementing implementations of the present disclosure. Although not shown, it is to be understood that one or more terminal devices may be located in the cell 102 and served by the network device 110.

In the communication network 100, the network device 110 can communicate data and control information to the terminal device 120 and the terminal device 120 can also communication data and control information to the network device 110. A link from the network device 110 to the terminal device 120 is referred to as a downlink (DL) or a forward link, while a link from the terminal device 120 to the network device 110 is referred to as an uplink (UL) or a reverse link.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

In communications, the terminal device 120 is configured to estimate and report CSI of a communication channel between the terminal device 120 and the network device 110. The CSI can be determined by the terminal device 120 using downlink reference signals transmitted by the network device 110.

Generally, feedback of CSI from the terminal device to the network device may be periodic or semi-persistent or aperiodic. For the periodic or semi-persistent feedback, periodic or semi-persistent CSI reference signals (CSI RS), which are preconfigured, are transmitted from the network device to the terminal device. Periodic or semi-persistent CSI reports for CSI or reference signal received power (RSRP) are generated based on the periodic or semi-persistent CSI RSs by the terminal device and transmitted to the network device. For the aperiodic feedback, the CSI RSs are preconfigured and the CSI reports for CSI or RSRP are aperiodically triggered, for example by downlink control information (DCI).

The terminal device may be configured with CSI-ReportConfig with a higher layer parameter report Quantity. The higher layer parameter reportQuantity indicates qualities which are to be reported to the network device and thus types of information (e.g. metrics related to CSI) to be included in the CSI report is determined based on the parameter report Quantity. Conventionally, the parameter reportQuantity may be set to one of the following: ‘none’, ‘cri-RI-PMI-CQI’, ‘cri-RI-il’, ‘cri-RI-it-CQI’, ‘cri-RI-CQI’, ‘cri-RSRP’, ‘ssb-Index-RSRP’ or ‘cri-RI-LI-PMI-CQI’, where cri refers to CSI-RS resource indicator, RI refers to rank indicator, PMI refers to precoding matrix indicator, CQI refers to channel quality indicator, it refers to codebook index, ssb refers to Synchronization Signal Block, and LI refers to layer indicator.

The CSI RS may be used for time/frequency tracking, CSI computation, L1-RSRP computation and mobility. As such, the terminal device may be configured with CSI RS(s) for time/frequency tracking (which may also be referred to as tracking RS herein). For example, a UE in radio resource control (RRC) connected mode is expected to receive the higher layer UE specific configuration of a NZP-CSI-RS-ResourceSet configured with higher layer parameter trs-Info. Moreover, a UE does not expect to be configured with a CSI-ReportConfig with the higher layer parameter reportQuantity set to other than ‘none’ for aperiodic NZP CSI-RS resource set configured with trs-Info.

As can be seen, in the conventional solution, the terminal device may be configured with CSI RS for tracking and a coherence measurement may thus be performed based on the CSI RS for tracking. However, a quantity related to coherence or a result of the coherence measurement is not fed back to the network device.

Example embodiments of the present disclosure provide a solution for CSI feedback. In the solution, the network device configures the terminal device to report a quantity related to coherence of a channel between the terminal device and the network device. Then, the terminal device determines a reference signal resource for coherence measurement of the channel and performs the coherence measurement using the determined reference signal resource. Information indication a result of the coherence measurement may be transmitted to the network device. The information may explicitly or implicitly indicate the result of the coherence measurement. This solution enables coherence report from the terminal device to the network device. In this way, the network device can be aware of further channel conditions and thus the communication between the network device and the terminal device can be controlled in a more accurate way.

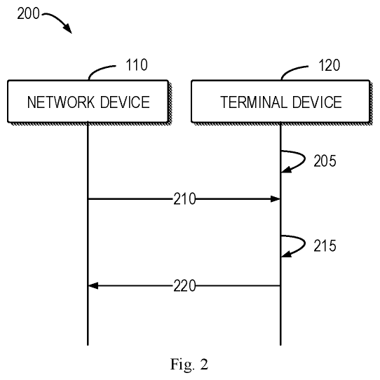

FIG. 2 is a schematic diagram illustrating an example process 200 in accordance with some embodiments of the present disclosure. As shown in FIG. 2, the example process 200 may involve the network device 110 and the terminal device 120. It is to be understood that the process 200 may include additional acts not shown and/or may omit some acts as shown, and the scope of the present disclosure is not limited in this regard. The process 200 may be associated with any of periodic, semi-persistent or aperiodic CSI report.

As shown in FIG. 2, the terminal device 120 determines 205 a reference signal (RS) resource for coherence measurement of a channel between the terminal device 120 and a network device 110. The RS resource may be periodic, semi-persistent or aperiodic resource. For example, the RS resource may be determined based on resource settings associated with the CSI.

In some example embodiments, the terminal device 120 may determine whether a CSI RS resource is configured for time or frequency tracking. If the CSI RS resource is configured for time or frequency tracking, the terminal device 120 may determine the CSI RS resource as the RS resource for the coherence measurement. If the CSI RS resource is configured for time or frequency tracking, the terminal device 120 may determine the RS resource for the coherence measurement based on a configuration of quasi co-location (QCL) for the CSI RS resource.

For example, the terminal device 120 may determine whether a CSI resource setting (periodic, semi-persistent or aperiodic) is configured with the trs-Info. If the resource setting is configured with trs-Info, the resource setting may be used by the terminal device 120 for coherence report. If the resource setting is not configured with trs-Info, the terminal device 120 may determine the ‘QCL-TypeA’ resource of the resource indicated by the resource setting.

Two examples may be as below. The terminal device 120 may indicate its capability (for example, UE capability) of CSI reporting to the network device 110. For example, the terminal device 120 may indicate to the network device 110 whether coherence reporting is supported by its capability. If the terminal device 120 can indicate its capability of CSI reporting based on NR release 17 or later, coherence report can be configured by the network device 110 to the terminal device 120. For aperiodic CSI, each trigger state configured using the higher layer parameter (e.g., CSI-AperiodicTriggerState) is associated with one or multiple CSI report configurations (e.g., CSI-ReportConfig) where each CSI report configuration is linked to periodic, or semi-persistent, or aperiodic resource setting(s). If the associated CSI resource setting is configured with trs-Info, the resource setting is used for CSI for coherence report; otherwise the resource setting is used for L1-RSRP computation. In some cases, for example when the terminal device 120 is required to report coherence to the network device 110, if the associated CSI resource setting is not configured with trs-Info, a resource set indicated by the resource setting is used for L1-RSRP, while the coherence report is based on the ‘QCL-TypeA’ RS associated with the resource set.

For semi-persistent or periodic CSI, each CSI report configuration (e.g., CSI-ReportConfig) is linked to periodic or semi-persistent Resource Setting(s). If the associated CSI resource setting is configured with trs-Info, the resource setting is used for CSI for coherence report; otherwise the resource setting is used for L1-RSRP computation. In some cases, for example when the terminal device 120 is required to report coherence to the network device 110, if the associated CSI resource setting is not configured with trs-Info, a resource set indicated by the resource setting is used for L1-RSRP, while the coherence report is based on the ‘QCL-TypeA’ RS associated with the resource set.

Still refer to FIG. 2. The network device 110 performs 210 transmission to the terminal device 120 using the RS resource. For example, the network device 110 may transmit a CSI RS using the RS resource. In some example embodiments, the network device 110 may transmit the tracking RS to the terminal device 120.

The terminal device 120 performs 215 the coherence measurement of the channel between the network device 110 and the terminal device 120 using the determined 205 RS resource. For example, the terminal device 120 may perform the coherence measurement based on the tracking RS. One or more metrics related to coherence of the channel between the network device 110 and the terminal device 120, which may be referred to as a coherence metric, may be determined by the terminal device 120 as a result of the coherence measurement.

Next, the terminal device 120 transmits 220 to the network device 110 information indicating the result of the coherence measurement for example as a part of CSI. The information may explicitly indicate the coherence of the channel or the result of the coherence measurement, which may correspond to an explicit coherence report. Alternatively, the information may implicitly indicate the coherence of the channel or the result of the coherence measurement, which may correspond to an implicit coherence report.

In some example embodiments, the terminal device 120 may determine, based on a parameter generated by the network device 110, whether to transmit the information indicating the result of the coherence measurement, for example whether to report the coherence. The terminal device 120 may determine, based on the parameter which may be transmitted via RRC signaling, whether a quantity related to coherence is to be reported to the network device 110. If the terminal device 120 determines that the quantity related to coherence is to be reported, then the terminal device 120 may transmit 220 the information to the network device 110.

As an example, the parameter used by the terminal device 120 may be the parameter reportQuantity as mentioned above. If the parameter reportQuantity is set to for example ‘coherence’ or ‘cri-RSRP-coherence’, the terminal device 120 may determine that the quantity related to coherence should be reported to the network device 110. In this case, the terminal device 120 (e.g., a UE) can be configured with a CSI report configuration (e.g., CSI-ReportConfig) with the higher layer parameter reportQuantity set to ‘coherence’ or ‘cri-RSRP-coherence’ for NZP CSI-RS resource set configured with trs-Info.

The parameter reportQuantity set to ‘coherence’ may indicate that non-beam specific coherence should be reported, while the parameter reportQuantity set to ‘cri-RSRP-coherence’ may indicate that beam specific coherence should be reported. It is to be understood that the parameter reportQuantity and its value are merely examples without any limitation. Any suitable parameter and/or specific value(s) may be employed to indicate coherence quantities to be reported to the network device.

In some example embodiments, the terminal device 120 may determine, based on a threshold, whether to transmit the information indicating the result of the coherence measurement, for example whether to report the coherence. For example, the terminal device 120 may be configured with a threshold. If a value of a corresponding parameter exceeds the threshold, the terminal device 120 may determine to report the coherence.

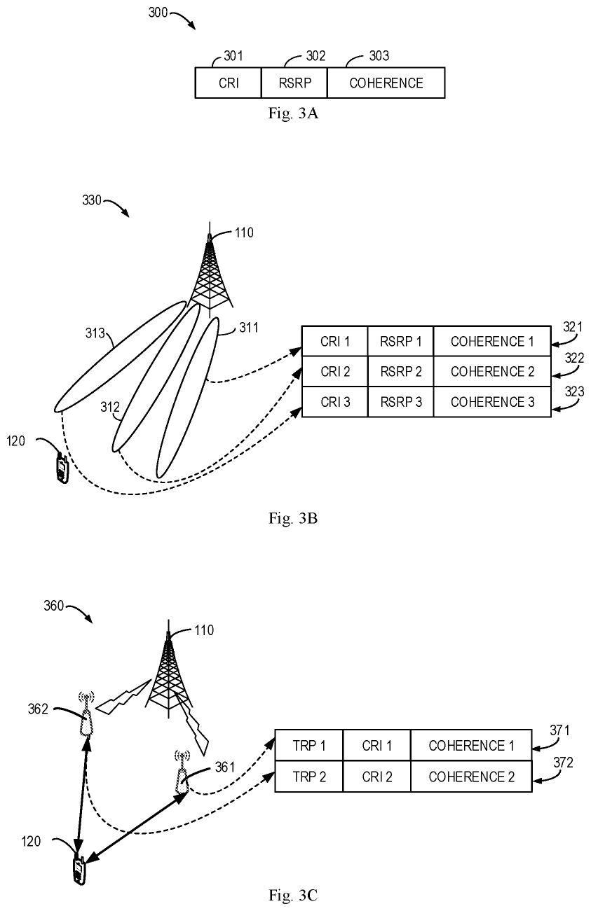

The coherence report may take a variety of forms. Now reference is made to FIGS. 3A-3C. FIG. 3A shows schematic diagram 300 illustrating an example structure for reporting coherence according to some embodiments of the present disclosure. The coherence report may be transmitted over physical uplink control channel (PUCCH). The example structure shown in FIG. 3A may be used for a wideband report. The example structure comprises three parts, i.e. part 301, part 302 and part 303. Part 301 and part 302 may be used to report CRI and RSRP, respectively. Part 303 may be used to report coherence in an explicit way or in an implicit way, as described below.

FIG. 3B shows schematic diagram 330 illustrating an example structure for reporting coherence according to some embodiments of the present disclosure. The example structure shown in FIG. 3B may be used for a beam specific report. As schematically shown in FIG. 3B, the network device 110 may communicate with the terminal device 120 via a plurality of beams, for example, beams 311-313. In this case, the CSI report including the coherence report may take a beam specific form. In the example structure shown in FIG. 3B, reports 321, 322 and 323 may correspond to beams 311, 312 and 313, respectively.

FIG. 3C shows schematic diagram 360 illustrating an example structure for reporting coherence according to some embodiments of the present disclosure. The example structure shown in FIG. 3C may be used for a TRP specific report. As schematically shown in FIG. 3C, the network device 110 may communicate with the terminal device 120 via different TRPs 361 and 362. In this case, the CSI report including the coherence report may take a TRP specific form. In the example structure shown in FIG. 3C, reports 371 and 372 may correspond to the TRPs 361 and 362, respectively.

Reference is now made back to FIG. 2. The terminal device 120 transmits 220 to the network device 110 information indicating the result of the coherence measurement. The information may explicitly or implicitly indicate the coherence of the channel. In some example embodiments, for example in the case of explicit coherence report, the transmitted information may comprise a metric related to coherence in time domain, and/or a metric related to coherence in frequency domain.

The metric related to coherence in time domain may include, but not limited to, Doppler spread and Doppler shift. The value of Doppler spread may be unified by the subcarrier spacing (SCS) of the tracking RS and the unified value of Doppler spread may be within the range from 0 to 1. Doppler spread and Doppler shift may reflect the time coherence of the channel between the network device 110 and the terminal device 120. A smaller Doppler spread means larger time coherence.

The metric related to coherence in frequency domain may include, but not limited to, delay spread and delay shift. The value of delay spread may be unified by the sampling interval (Tc) of the tracking RS and the unified value of delay spread may be within the range from 0 to CP/Tc, where CP refers to cyclic prefix. Delay spread and delay shift may reflect the frequency coherence of the channel between the network device 110 and the terminal device 120. A smaller delay spread means larger frequency coherence.

The metric reported to the network device 110 may be configurable, for example by the network device 110. The metric included in the coherence report may comprise one or more of the following: Doppler spread, Doppler shift, delay spread, delay shift or any combination thereof. As an example, the coherence report may only comprise the metric related to coherence in time domain, for example, Doppler spread and/or Doppler shift. As another example, the coherence report may only comprise the metric related to coherence in frequency domain, for example, delay spread and/or delay shift.

In some example embodiments, for example in the case of implicit coherence report, the transmitted 220 information may comprise information concerning one or more communication settings, which are determined or selected by the terminal device 120 based on the result of the coherence measurements. For example, the network device 110 may configure multiple candidate settings for one or more coherence report types by RRC signaling and activate a subset of the candidate settings by a media access control (MAC) control element (CE). Then, the terminal device 120 may select a setting from the activated subset based on the result of coherence measurements and report the selected setting to the network device 110. The selected setting may be considered as a setting recommended or preferred by the terminal device 120.

After receiving the implicit coherence report, which includes the selected setting, the network device 110 may determine or infer the coherence and determine whether to adjust a corresponding configuration or setting. If the corresponding setting needs to be adjusted, the network device 110 may transmit control information with the new setting to the terminal device 120. The new setting may be the same as or different from the setting which is selected by the terminal device 120.

Different types of communication settings may be used. Example types of communication settings includes, but not limited to, a setting for reporting CSI, a setting for transmission of CSI RS, a setting for bundling DMRSs in time domain, a setting for bundling DMRSs in frequency domain and any combination thereof

The setting for bundling DMRSs (e.g., DMRSs of PDSCH) in frequency domain may include bundling size of DMRSs in terms of physical resource block (PRB). The bundling size may be wideband, 1 PRB, 2 PRBs or 4 PRBs. Alternatively or in addition, the setting for bundling DMRSs in frequency domain may include the number of DMRS overhead reduction, which may be one of density1, density0.5, density2. A recommended or preferred bundling size and/or number of DMRS overhead reduction may be selected by the terminal device 120 and reported to the network device 110. Indication of the selected setting for bundling DMRSs in frequency domain may occupy for example 2 bits in the uplink control channel. In some example embodiments, different combinations of the bundling size and number of DMRS overhead reduction may be configured and the terminal device 120 may select a combination of a certain bundling size and number of DMRS overhead reduction.

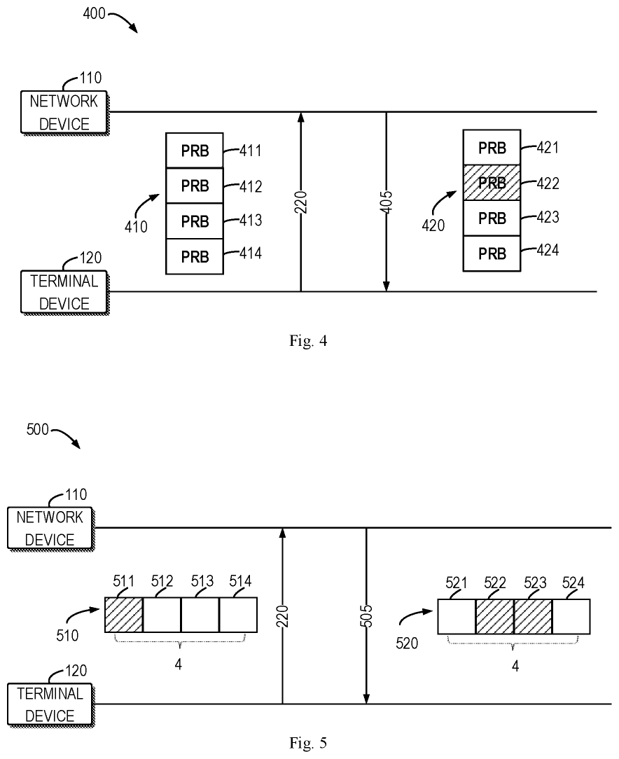

Reference is made to FIG. 4, which shows a schematic diagram 400 illustrating bundling of DMRSs in frequency domain according to some embodiments of the present disclosure. As shown in FIG. 4, before transmitting 220 the coherence report, bundling configuration 410 is employed. For the PRBs 411-414, the DMRSs for PRB 411 and PRB 412 are bundled, which means precoders of these DMRSs are the same. That is, before coherence report, the bundling size of DMRSs in frequency domain is 2 in terms of PRB. After receiving the coherence report, the network device 110 may transmit 405 control information (e.g. downlink control information, DCI) with a new setting for bundling DMRSs in frequency domain. Bundling configuration 420 may be employed based on the new setting. As shown, DMRSs for four PRBs 421-424 are bundled.

The setting for bundling DMRSs (e.g., DMRSs of PDSCH) in time domain may include the number of transmission occasions across which the DMRSs are bundled. The terminal device 120 may be configured with a plurality of transmission occasions (may also be referred to as “transmission repetitions”) to be scheduled by single control information. For example, the terminal device 120 may be configured with a plurality of transmission occasions of PDSCH to be scheduled by single DCI. For example, the same data or transport blocks can be included in the plurality of transmission occasions, and may be associated with different redundancy versions in channel coding. In some example embodiments, a transmission occasion may correspond to a slot or a mini slot. For purpose of discussion, the number of transmission occasions across which the DMRSs are bundled may be referred to as the number of bundling transmission occasions or bundling size in time domain. The number of bundling transmission occasions may be a predetermined value, such as 1, 2, 4 or 8.

Alternatively or in addition, the setting for bundling DMRSs in time domain may include the number of additional DMRS positions or density. The number of additional DMRS positions may be one of pos0, posl, pos2, pos3. A recommended or preferred number of bundling transmission occasions and/or number of additional DMRS positions or density may be selected by the terminal device 120 and reported to the network device 110. Indication of the selected setting for bundling DMRSs in time domain may occupy for example 2 bits in the uplink control channel. In some example embodiments, different combinations of the number of bundling transmission occasions and number of additional DMRS positions or density may be configured and the terminal device 120 may select a certain combination thereof

Reference is made to FIG. 5, which shows a schematic diagram 500 illustrating bundling of DMRSs in time domain according to some embodiments of the present disclosure. The plurality of transmission occasions 511-514 and 521-524 as shown may correspond to slots or mini slots in time domain. For purpose of discussion, the number of the plurality of transmission occasions which are configured to the terminal device 120 may be referred to as time aggregation level. In the example of FIG. 5, the terminal device 120 may be configured with a time aggregation level of 4.

As shown in FIG. 5, before transmitting 220 the coherence report, bundling configuration 510 is employed. As shown, before coherence report, the bundling size of DMRSs in time domain is 1 in terms of transmission occasions. After receiving the coherence report, the network device 110 may transmit 505 control information (e.g., DCI) with a new setting for bundling DMRSs in time domain. Bundling configuration 520 may be employed based on the new setting. As shown, DMRSs are bundled across the four transmission occasions 521-524.

The setting for reporting CSI may include the subband number or subband size for reporting CSI. Alternatively or in addition, the setting for reporting CSI may include the granularity for reporting CSI, which may be wideband or subband. A recommended or preferred subband number, subband size and/or granularity may be selected by the terminal device 120 and reported to the network device 110. In some example embodiments, different combinations of the subband numbers, subband sizes and/or granularities may be configured and the terminal device 120 may select a combination of a certain subband number, subband size and/or granularity.

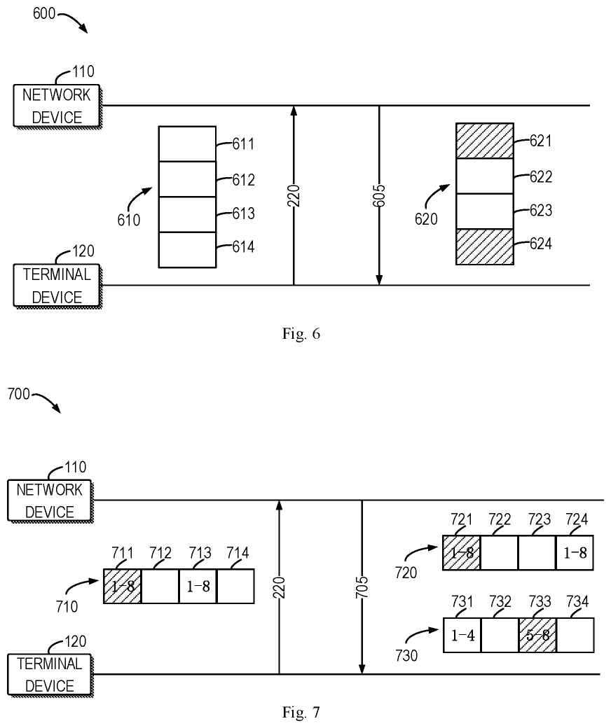

Reference is made to FIG. 6, which shows a schematic diagram 600 illustrating settings related to CSI in frequency domain according to some embodiments of the present disclosure. As shown in FIG. 6, before transmitting 220 the coherence report, reporting configuration 610 is employed where CSI is reported for every other subband or in other words at an interval of one subband. For the subbands 611-614, CSI is reported for the subband 611 and subband 613. After receiving the coherence report, the network device 110 may transmit 605 control information (e.g., DCI) with a new setting for reporting CSI. Reporting configuration 620 may be employed based on the new setting. As shown, CSI may be reported at an interval of two subbands, for example CSI may be reported for the subband 621 and subband 624.

The setting for transmission of CSI RSs may include the RB number or density in frequency for transmitting/receiving CSI RSs. Alternatively or in addition, the setting for transmission of CSI RSs may include the periodicity of the CSI RSs. A recommended or preferred the RB number, density in frequency and/or periodicity may be selected by the terminal device 120 and reported to the network device 110. In some example embodiments, different combinations of the RB number, density in frequency and/or periodicity may be configured and the terminal device 120 may select a combination of a certain the RB number, density in frequency and/or periodicity.

Reference is made to FIG. 7, which shows a schematic diagram 700 illustrating settings related to CSI in time domain according to some embodiments of the present disclosure. The time slots 711-714, 721-724 and 731-734 as shown may be slots or mini slots. As shown in FIG. 7, before transmitting 220 the coherence report, configuration 710 is employed. As shown, before coherence report, measurement of CSI is performed at an interval of one time slot. For example, measurement of CSI is performed over the time slots 711 and 713. For each of the time slots 711 and 713, measurement is performed on ports 1-8. After receiving the coherence report, the network device 110 may transmit 705 control information (e.g., DCI) with a new setting for transmission of CSI RSs.

As an example, configuration 720 may be employed based on the new setting. As shown, measurement of CSI is performed at an interval of two time slots. For example, measurement of CSI is performed over the time slots 721 and 724. For each of the time slots 721 and 724, measurement is performed on ports 1-8. As another example, configuration 730 may be employed based on the new setting. As shown, measurement of CSI is still performed at an interval of one time slot while the number of ports is reduced.

For example, measurement of CSI is performed over the time slots 731 and 733. For the time slot 731, measurement is performed on ports 1-4, while for the time slot 733, measurement is performed on ports 5-8.

It is to be understood that the configurations shown in FIGS. 4-7 are merely given as examples without any limitation. A variety of suitable configurations or settings may be employed. Moreover, the explicit report and the implicit report may be combined. For example, both the coherence metric (for example, Doppler spread, Doppler shift, delay spread, delay shift) and the selected communication settings can be reported to the network device 110.

In the above, some example embodiments are described to illustrate the feedback of coherence. In this way, the network device can be aware of further channel conditions and thus the communication between the network device and the terminal device can be controlled in a more accurate way.

As mentioned above, the terminal device 120 may be configured with a plurality of transmission occasions to be scheduled by single control information. DMRSs for these transmission occasions may be bundled across some or all of these transmission occasions. In this event, how to indicate the number of transmission occasions across which DMRSs are bundled needs to be specified.

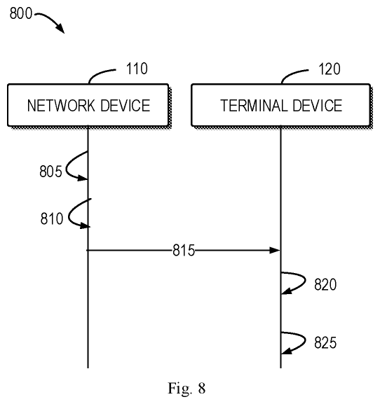

FIG. 8 is a schematic diagram illustrating an example process 800 in accordance with some embodiments of the present disclosure. As shown in FIG. 8, the example process 800 may involve the network device 110 and the terminal device 120. It is to be understood that the process 800 may include additional acts not shown and/or may omit some acts as shown, and the scope of the present disclosure is not limited in this regard.

As shown in FIG. 8, the network device 110 determines 805 the number of transmission occasions across which DMRSs are bundled, and the DMRSs are to be transmitted to the terminal device 120. As mentioned above, the number of transmission occasions across which DMRSs are bundled may also be referred to as the number of bundling transmission occasions. For example, multiple transmission occasions can correspond to multiple slots, or multiple time mini-slots. Then, the network device 110 generates 810 control information indicating the number of the transmission occasions across which DMRSs are bundled, i.e., indicating the number of bundling transmission occasions. In an example, the number of bundling transmission occasions can be semi-statically configured by the higher-layer signaling. In another example, DCI with an indication indicating the time bundling size of the DMRSs can be generated. The indication indicating the time bundling size of the DMRSs may be referred to as a time bundling size indication herein, which may be included in DCI format 1_1. In some example embodiments, this indication may occupy 2 bits. In some example embodiments, this indication may occupy only 1 bit. For example, the network device 110 can apply the same precoders for the DMRSs in the indicated different transmission occasions.

The network device 110 transmits 815 the generated control information to the terminal device 120. For example, the network device 110 may transmit the DCI with the time bundling size indication to the terminal device 120. The terminal device 120 determines 820 the number of transmission occasions across which the DMRSs are bundled, based on the received control information. Then, the terminal device 120 performs 825 joint channel estimation based on the DMRSs received from the network device 110 across the transmission occasions. For example, the terminal device 120 can assume that the precoders for the DMRS received in the determined number of transmission occasions are the same, such that the channel estimation based on the DMRSs from different transmission occasions can be interpolated.

Now detailed description is given on how to determine the number of bundling transmission occasions, and an example of the transmission occasion may be a slot or a mini-slot. The number of bundling transmission occasions P′ may have a value selected from the group consisting of 1, 2, 4 and 8.

In some example embodiments, the control information may comprise 2 bits to indicate the number of bundling transmission occasions P′. For example, the time bundling size indication may occupy 2 bits with different patterns of the 2 bits corresponding to the values of 1, 2, 4 and 8.

In some example embodiments, the control information may comprise only one bit to indicate the number of bundling transmission occasions P′. In this case, the time bundling size indication may occupy one bit in the DCI. The terminal device 120 may be configured with different numbers of transmission occasions, i.e., different time aggregation levels. The time aggregation level of the terminal device 120 may be fixed and signaled by RRC.

If the terminal device 120 is configured with a time aggregation level of 2, which may be the lowest aggregation level, the terminal device 120 may determine the number of bundling transmission occasions P′, based on the value of the time bundling size indication. For example, if the time bundling size indication is assigned with ‘0’, the terminal device 120 may determine the number of bundling transmission occasions P′ as 1. That is, the terminal device 120 may use the P′ with a value of 1 when receiving the transmission occasions of the PDSCH scheduled by the same DCI. If the time bundling size indication is assigned with ‘1’, the terminal device 120 may determine the number of bundling transmission occasions P′ as 2. That is, the terminal device 120 may use the P′ with a value of 2 when receiving the transmission occasions of the PDSCH scheduled by the same DCI.

In some example embodiments, the network device 110 may additionally generate two sets of values to indicate the number of bundling transmission occasions P′. Values in the two sets, which may be referred to as configured values, may be selected from the group consisting of 1, 2 and 4 (without 8), for example. The number of values in the first set may be equal to or larger than the number of values in the second set. For example, the first set of values may include one or two values, while the second set of values may include only one value. Value(s) in the first set are different from the value(s) in the second set. The first set of values and the second set of values may be transmitted to the terminal device 120 by RRC signaling.

If the terminal device 120 is configured with a time aggregation level higher than 2, for example, 4 or 8, the terminal device 120 may determine the number of bundling transmission occasions P′, based on the value of the time bundling size indication and at least one of the first and second sets of values.

For example, if the time bundling size indication is assigned with ‘0’, the terminal device 120 may determine the value in the second set as the number of bundling transmission occasions P′. That is, the terminal device 120 may use the P′ with the value in the second set when receiving the transmission occasions of the PDSCH scheduled by the same DCI.

If the time bundling size indication is assigned with ‘1’, the terminal device 120 may determine the number of bundling transmission occasions P′ further based on the first set. If the first set comprises only one value, then the terminal device 120 may determine the value in the first set as the number of bundling transmission occasions P′. If the first set comprises more than one values (e.g., two values), the terminal device 120 may determine the number of bundling transmission occasions P′ further based on the time aggregation level. For example, if the time aggregation level is larger than 4, for example 8 or larger, the value of the aggregation level may be determined as the number of bundling transmission occasions P′. If the time aggregation level is equal to or smaller than 4, the value other than the ones in the first set among the configured values may be determined as the number of bundling transmission occasions P′.

In such example embodiments, the number of transmission occasions across which DMRSs are bundled can be indicated to the terminal device with one bit. In this way, the signaling overhead is reduced. The solution for indicating the time bundling size of DMRSs and the solution for CSI feedback may be implemented in combination or independently.

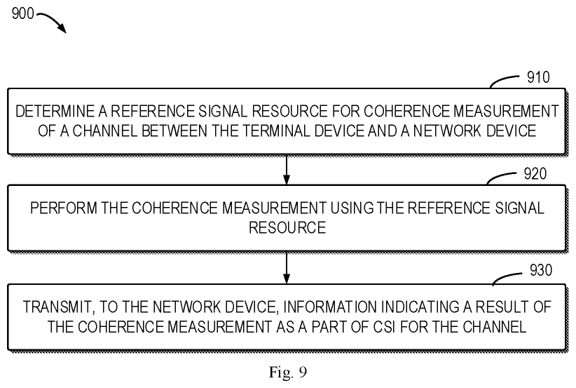

FIG. 9 illustrates a flowchart of an example method 900 according to some embodiments of the present disclosure. The method 900 can be implemented at the terminal device 120 as shown in FIG. 1. It is to be understood that the method 900 may include additional blocks not shown and/or may omit some blocks as shown, and the scope of the present disclosure is not limited in this regard. For the purpose of discussion, the method 900 will be described from the perspective of the terminal device 120 with reference to FIG. 1.

At block 910, the terminal device 120 determines a reference signal resource for coherence measurement of a channel between the terminal device 120 and a network device 110. At block 920, the terminal device 120 performs the coherence measurement using the reference signal resource. At block 930, the terminal device 120 transmits, to the network device 110, information indicating a result of the coherence measurement as a part of CSI for the channel.

In some example embodiments, determining the reference signal resource for the coherence measurement comprises: determining whether a CSI RS resource is configured for time or frequency tracking; and in accordance with a determination that the CSI RS resource is configured for time or frequency tracking, determining the CSI RS resource as the reference signal resource for the coherence measurement

In some example embodiments, the method 900 further comprises: in accordance with a determination that the CSI RS resource is not configured for time or frequency tracking, determining the reference signal resource for the coherence measurement based on a configuration of quasi co-location for the CSI RS resource.

In some example embodiments, the transmitted information comprises at least one of the following: a metric related to coherence in time domain, or a metric related to coherence in frequency domain.

In some example embodiments, the transmitted information comprises at least one of the following determined based on the result of the coherence measurement: a first setting for reporting CSI, a second setting for transmission of CSI RSs, a third setting for bundling demodulation reference signals, DMRSs, in time domain, or a fourth setting for bundling DMRSs in frequency domain.

In some example embodiments, the method 900 further comprises: receiving, from the network device 110, at least one of the following: a fifth setting for reporting CSI, a sixth setting for transmission of CSI RSs, a seventh setting for bundling DMRSs in time domain, or an eighth setting for bundling DMRSs in frequency domain.

In some example embodiments, transmitting the information indicating the result of the coherence measurement comprises: determining, based on a parameter generated by the network device, whether a quantity related to coherence is to be reported to the network device; and in accordance with a determination that the quantity related to coherence is to be reported, transmitting the information to the network device.

In some example embodiments, the method 900 further comprises: receiving control information from the network device 110; determining, based on the control information, the number of transmission occasions across which DMRSs are bundled; and performing joint channel estimation based on the DMRSs received from the network device across the transmission occasions.

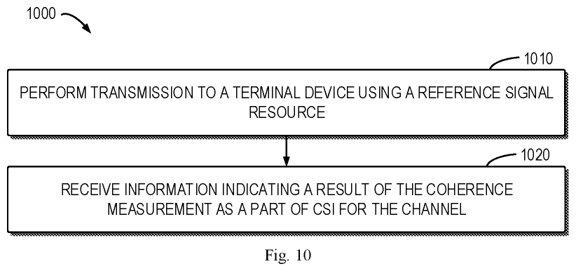

FIG. 10 illustrates a flowchart of an example method 1000 according to some embodiments of the present disclosure. The method 1000 can be implemented at the network device 110 as shown in FIG. 1. It is to be understood that the method 1000 may include additional blocks not shown and/or may omit some blocks as shown, and the scope of the present disclosure is not limited in this regard. For the purpose of discussion, the method 1000 will be described from the perspective of the network device 110 with reference to FIG. 1.

At block 1010, the network device 110 performs transmission to a terminal device 120 using a reference signal resource, to enable the terminal device 120 to perform a coherence measurement of a channel between the terminal device 120 and the network device 110. At block 1020, the network device 110 receives, from the terminal device 120, information indicating a result of the coherence measurement as a part of CSI for the channel.

In some example embodiments, the received information comprises at least one of the following: a metric related to coherence in time domain, or a metric related to coherence in frequency domain.

In some example embodiments, the received information comprises at least one of the following: a first setting for reporting CSI, a second setting for transmission of CSI RSs, a third setting for bundling demodulation reference signals, DMRSs, in time domain, or a fourth setting for bundling DMRSs in frequency domain.

In some example embodiments, the method 1000 further comprises: determining, based on the received information, at least one of the following: a fifth setting for reporting CSI, a sixth setting for transmission of CSI RSs, a seventh setting for bundling DMRSs in time domain, or an eighth setting for bundling DMRSs in frequency domain; and transmitting, to the terminal device 120, the at least one determined based on the received information.

In some example embodiments, the method 1000 further comprises: generating a parameter indicating that a quantity related to coherence is to be reported to the network device 110; and transmitting the parameter to the terminal device 120.

In some example embodiments, the method 1000 further comprises: determining the number of transmission occasions across which DMRSs are bundled, the DMRSs to be transmitted to the terminal device 120; generating control information indicating the number of the transmission occasions; and transmitting the control information to the terminal device to enable the terminal device 120 to perform joint channel estimation based on the DMRSs received across the transmission occasions.

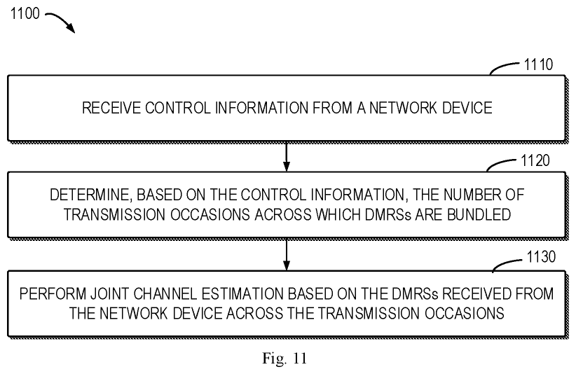

FIG. 11 illustrates a flowchart of an example method 1100 according to some embodiments of the present disclosure. The method 1100 can be implemented at the terminal device 120 as shown in FIG. 1. It is to be understood that the method 1100 may include additional blocks not shown and/or may omit some blocks as shown, and the scope of the present disclosure is not limited in this regard. For the purpose of discussion, the method 1100 will be described from the perspective of the terminal device 120 with reference to FIG. 1.

At block 1110, the terminal device 120 receives control information from a network device 110. At block 1120, the terminal device 120 determines, based on the control information, the number of transmission occasions across which DMRSs are bundled. At block 1130, the terminal device 120 performs joint channel estimation based on the DMRSs received from the network device 110 across the transmission occasions.

In some example embodiments, the terminal device 120 is configured with the lowest number of transmission occasions (e.g., 2) among a plurality of predetermined numbers (for example, 2, 4, 8). Determining the number of the transmission occasions comprises: determining the number of the transmission occasions based on a value of a bit comprised in the control information.

In some example embodiments, the terminal device 120 is configured with a predetermined number of transmission occasions other than the lowest number among a plurality of predetermined numbers. Determining the number of the transmission occasions comprises: obtaining a first set of values and a second set of values generated by the network device 110, the number of values in the first set being equal to or larger than the number of values in the second set, values in the first set different from values in the second set; and determining the number of the transmission occasions based on a value of a bit comprised in the control information and at least one of the first set and the second set.

In some example embodiments, determining the number of the transmission occasions based on the value of the bit and at least one of the first set and the second set comprises: in accordance with a determination that the bit is assigned with a first predetermined value, determining a value in the second set as the number of the transmission occasions; and in accordance with a determination that the bit is assigned with a second predetermined value different from the first predetermined value, determining the number of the transmission occasions based on the first set

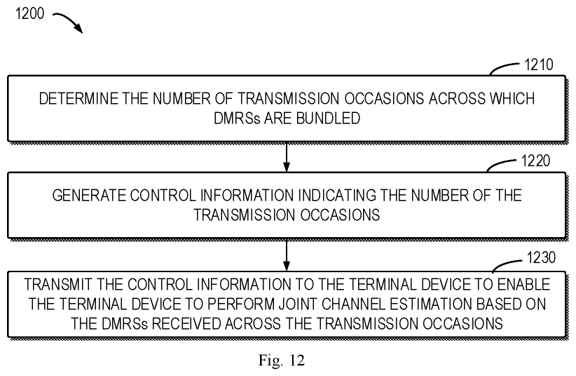

FIG. 12 illustrates a flowchart of an example method 1200 according to some embodiments of the present disclosure. The method 1200 can be implemented at the network device 110 as shown in FIG. 1. It is to be understood that the method 1200 may include additional blocks not shown and/or may omit some blocks as shown, and the scope of the present disclosure is not limited in this regard. For the purpose of discussion, the method 1200 will be described from the perspective of the network device 110 with reference to FIG. 1.

At block 1210, the network device 110 determines the number of transmission occasions across which DMRSs are bundled, and the DMRSs are to be transmitted to a terminal device 120. At block 1220, the network device 110 generates control information indicating the number of the transmission occasions. At block 1230, the network device 110 transmits the control information to the terminal device 120 to enable the terminal device 120 to perform joint channel estimation based on the DMRSs received across the transmission occasions.

In some example embodiments, the terminal device 120 is configured with the lowest number of transmission occasions among a plurality of predetermined numbers. Generating the control information comprises: assigning a value of a bit comprised in the control information based on the number of the transmission occasions.

In some example embodiments, the terminal device 120 is configured with a predetermined number of transmission occasions other than the lowest number among a plurality of predetermined numbers. Generating the control information comprises: generating a first set of values and a second set of values, the number of values in the first set being equal to or larger than the number of values in the second set, values in the first set different from values in the second set; and assigning a value of a bit comprised in the control information based on the number of the transmission occasions and at least one of the first set and the second set.

In some example embodiments, assigning the value of the bit comprises: determining whether the number of the transmission occasions is comprised in the second set; in accordance with a determination that the number of the transmission occasions is comprised in the second set, assigning the bit with a first predetermined value; and in accordance with a determination that the number of the transmission occasions is not comprised in the second set, assigning the bit with a second predetermined value different from the first predetermined value.

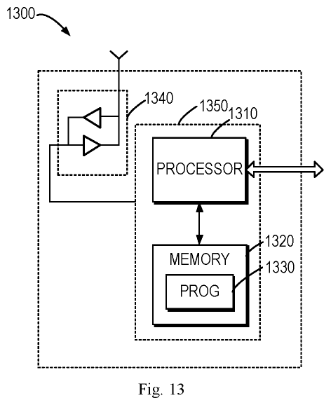

FIG. 13 is a simplified block diagram of a device 1300 that is suitable for implementing embodiments of the present disclosure. The device 1300 can be considered as a further example implementation of the network device 110 or the terminal device 120 as shown in FIG. 1. Accordingly, the device 1300 can be implemented at or as at least a part of the network device 110 or the terminal device 120.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1320 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1330 is assumed to include program instructions that, when executed by the associated processor 1310, enable the device 1300 to operate in accordance with the embodiments of the present disclosure, as discussed herein with reference to FIGS. 1 to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2, 8-12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-30. (canceled)

31. A method for communication comprising:
determining, at a terminal device, a reference signal resource for coherence measurement of a channel between the terminal device and a network device;
performing the coherence measurement using the reference signal resource; and
transmitting, to the network device, information indicating a result of the coherence measurement as a part of channel state information, CSI, for the channel.

32. The method of claim 31, wherein determining the reference signal resource for the coherence measurement comprises:
determining whether a CSI reference signal, CSI RS, resource is configured for time or frequency tracking; and
in accordance with a determination that the CSI RS resource is configured for time or frequency tracking, determining the CSI RS resource as the reference signal resource for the coherence measurement.

33. The method of claim 32, further comprising:
in accordance with a determination that the CSI RS resource is not configured for time or frequency tracking, determining the reference signal resource for the coherence measurement based on a configuration of quasi co-location for the CSI RS resource.

34. The method of claim 31, wherein the transmitted information comprises at least one of the following:
a metric related to coherence in time domain, or
a metric related to coherence in frequency domain.

35. The method of claim 31, wherein the transmitted information comprises at least one of the following determined based on the result of the coherence measurement:
a first setting for reporting CSI,
a second setting for transmission of CSI RSs,
a third setting for bundling demodulation reference signals, DMRSs, in time domain, or
a fourth setting for bundling DMRSs in frequency domain.

36. The method of claim 35, further comprising:
receiving, from the network device, at least one of the following:
a fifth setting for reporting CSI,
a sixth setting for transmission of CSI RSs,
a seventh setting for bundling DMRSs in time domain, or
an eighth setting for bundling DMRSs in frequency domain.

37. The method of claim 31, wherein transmitting the information indicating the result of the coherence measurement comprises:
determining, based on a parameter generated by the network device, whether a quantity related to coherence is to be reported to the network device; and
in accordance with a determination that the quantity related to coherence is to be reported, transmitting the information to the network device.

38. The method of claim 31, further comprising:
receiving control information from the network device;
determining, based on the control information, the number of transmission occasions across which DMRSs are bundled; and
performing joint channel estimation based on the DMRSs received from the network device across the transmission occasions.

39. A method for communication comprising:
receiving, at a terminal device, control information from a network device;
determining, based on the control information, the number of transmission occasions across which demodulation reference signals, DMRSs, are bundled; and
performing joint channel estimation based on the DMRSs received from the network device across the transmission occasions.

40. The method of claim 39, wherein the terminal device is configured with the lowest number of transmission occasions among a plurality of predetermined numbers, and wherein determining the number of the transmission occasions comprises:
determining the number of the transmission occasions based on a value of a bit comprised in the control information.

41. The method of claim 39, wherein the terminal device is configured with a predetermined number of transmission occasions other than the lowest number among a plurality of predetermined numbers, and wherein determining the number of the transmission occasions comprises:
obtaining a first set of values and a second set of values generated by the network device, the number of values in the first set being equal to or larger than the number of values in the second set, values in the first set different from values in the second set; and
determining the number of the transmission occasions based on a value of a bit comprised in the control information and at least one of the first set and the second set.

42. The method of claim 40, wherein determining the number of the transmission occasions based on the value of the bit and at least one of the first set and the second set comprises:
in accordance with a determination that the bit is assigned with a first predetermined value, determining a value in the second set as the number of the transmission occasions; and
in accordance with a determination that the bit is assigned with a second predetermined value different from the first predetermined value, determining the number of the transmission occasions based on the first set.

43. A method for communication comprising:
performing, at a network device, transmission to a terminal device using a reference signal resource, to enable the terminal device to perform a coherence measurement of a channel between the terminal device and the network device; and
receiving, from the terminal device, information indicating a result of the coherence measurement as a part of channel state information, CSI, for the channel.

44. The method of claim 43, the received information comprises at least one of the following:
a metric related to coherence in time domain, or
a metric related to coherence in frequency domain.

45. The method of claim 43, wherein the received information comprises at least one of the following:
a first setting for reporting CSI,
a second setting for transmission of CSI RSs,
a third setting for bundling demodulation reference signals, DMRSs, in time domain, or
a fourth setting for bundling DMRSs in frequency domain.

46. The method of claim 45, further comprising:
determining, based on the received information, at least one of the following:
a fifth setting for reporting CSI,
a sixth setting for transmission of CSI RSs,
a seventh setting for bundling DMRSs in time domain, or
an eighth setting for bundling DMRSs in frequency domain; and
transmitting, to the terminal device, the at least one determined based on the received information.

47. The method of claim 43, further comprising:
generating a parameter indicating that a quantity related to coherence is to be reported to the network device; and
transmitting the parameter to the terminal device.

48. The method of claim 43, further comprising:
determining the number of transmission occasions across which DMRSs are bundled, the DMRSs to be transmitted to the terminal device;
generating control information indicating the number of the transmission occasions; and
transmitting the control information to the terminal device to enable the terminal device to perform joint channel estimation based on the DMRSs received across the transmission occasions.
